(19) United States
(12) Patent Application Publication
(10) Pub. No.: US 2011/0154677 A1
(43) Pub. Date: Jun. 30, 2011

(54) Ringed Umbrella Dryer

(76) Inventor: Scott Pudalov, New York, NY (US)

(21) Appl. No.: 12/648,991

(22) Filed: Dec. 29, 2009

(51) Int. Cl. F26B 25/00

(52) U.S. Cl. 34/107

(57) ABSTRACT

An apparatus for removing water from an unfurled umbrella having a member with bristles to receive the axial length of an unfurled umbrella such that the at least one bristle support member surrounds the umbrella by at least 180 degrees, so the plurality of bristles compress the umbrella and remove water from the umbrella as the umbrella passes through the member with bristles.

### FIELD OF THE INVENTION

This invention relates to a water removal device that removes water from a wet unfurled umbrella.

### BACKGROUND OF THE INVENTION

Wet umbrellas pose a problem, if not a serious inconvenience for society. Water brought into buildings, apartments, or homes, via an umbrella may cause a person to slip and fall, may cause dirt and debris to enter the building, and may pose a hazard, as wet umbrellas are often placed in public areas.

Particularly prevalent in large cities, wet umbrellas pose a continuous problem for store owners, building owners and even home owners whenever it drizzles or rains. In the lobbies of buildings and in homes, wet umbrellas may cause the floor to become wet, resulting in hazardous, slippery conditions. In stores, wet umbrellas may cause slippery conditions in high foot traffic areas and may cause water damage to various merchandise, for example, as wet umbrellas often brush up against goods.

What is desired therefore is a device that allows a person to remove water from an umbrella. More specifically, what is desired is a device that allows for the majority of water from an umbrella to be removed quickly and efficiently.

What is further desired is for a water removal device that may be a handheld device, a device able to be placed on the floor and stand on its own, or a device that is able to be fixed to the side of the building for communal use. Each design for a water removal device has various advantages and disadvantages.

It is further desired for the water removing device to have bristles or inner bristles, such that these bristles may remove water from an umbrella.

It is further desired for the water removal device to have various orientations, such as being vertical, horizontal, or angled, allowing for an umbrella to enter the device at various angles, making it easy for a person to insert an umbrella into the device.

It is further desired for the bristles or plurality of bristles of the device to be oriented in the same direction as the umbrella entry into the device. In another construction, it is further desired for the bristles to project radially inward towards the axial center of the device. It is further desired for the bristles to project at various angles compared to the umbrella entry into the device.

It is further desired for the device to have a removable catch basin for catching the water removed from an umbrella. It is further desired for the device to have either an open or closed housing, shell, or body.

It is further desired for the device to have various patterns and assortments of bristles to easily remove water. Such bristles may be arranged in a ring, hexagon, triangle, or such other configuration, or may be arranged either horizontally or vertically, providing various orientations for water to be easily removed from an umbrella. It is further desired for multiple layers of bristles to be supported by the device in various bristle support members.

It is further desired for the bristles to be able rotate or be operated via a motor, such that the bristles may spin to remove water from an umbrella.

It is further desired for the device to be used upon an unfurled umbrella, such that the bristles are able to compress the umbrella resulting in the removal of water.

### SUMMARY OF THE INVENTION

Accordingly, it is an object of the present invention to provide a device that removes water from an umbrella, more specifically an unfurled umbrella. An unfurled umbrella is defined as an umbrella that is not in its open position, but rather the umbrella is in its collapsed position where it is still loose and not strapped tightly by a piece of fabric. An unfurled umbrella may still further be compressed, such compression allowing for water to be removed from the umbrella.

It is a further object of the present invention to provide a device that allows for the majority of water from an umbrella to be removed quickly and efficiently.

It is a further object of the invention for the device to be either a handheld device, a device able to be placed on the floor that may stand on its own, or a device that may be fixed to the side of the building for communal use, such device able to remove water from an umbrella.

It is a further object of the invention for the device to have bristles, such as inner bristles, so that such bristles may remove water from an umbrella. It is a further object of the invention for the body of the device to have various orientations, such as having a vertical, horizontal, curved or angled orientation, allowing for an umbrella to enter the device at various angles, such that entry of an umbrella into the device is easy for a person carrying an umbrella.

It is a further object of the invention for the bristles to be oriented in the same direction as an umbrella entry into the device. In another construction, it is a further object of the invention for the bristles to project radially inward towards the axial center of the device. In another construction, the bristles may project in at various angles relative to an umbrella entry into the device.

It is a further object for the device to have a removable catch basin for catching the water removed from an umbrella.

It is a further object for the bristles of the device to have various patterns, such as being oriented or arranged in a ring, triangle, hexagon or other such orientation. It is a further object for the bristles of the device to be contained by an enclosed member or partially enclosed member. It is a further object for the bristles of the device to be arranged within multiple enclosed members. It is further object of the invention for the bristles to be arranged in both enclosed members and vertically in the same direction as an umbrella entry into the device.

It is a further object of the invention for the bristles to rotate or be operated via a motor, allowing for the bristles to spin.

These and other objectives are achieved by providing an apparatus for removing water from an unfurled umbrella comprising: at least one bristle support member having an opening adapted to receive the axial length of the unfurled umbrella such that the at least one bristle support member surrounds the umbrella by at least 180 degrees, a plurality of bristles located within the at least one bristle support member, the plurality of bristles having the proximal end of each bristle attached to the at least one bristle support member, the at least one bristle support member and the plurality of bristles being sized and spaced apart to receive the umbrella and to compress the umbrella and brush against the fabric of the umbrella to remove water from the umbrella as the umbrella passes through the at least one bristle support member.

The diameter of the at least one bristle support member may be greater than the diameter of the unfurled umbrella when the umbrella is compressed by the plurality of bristles.

There may be more than one bristle support member, each such bristle support member being located in a plane with the other bristle support members. When entering the device, an umbrella may pass through more the more than one bristle support member.

The at least one bristle support member may surround the umbrella by up to and including 360 degrees, so as to partially or completely surround the umbrella, as the umbrella passes through the bristle support member.

The apparatus may have the plurality of bristles project radially towards the center of the at least one bristle support member. In certain arrangements, the plurality of bristles may be spaced symmetrically within the at least one bristle support member.

The distance between the distal end of a first bristle and the distal end of a corresponding second bristle located across the at least one bristle support member may be greater than the diameter of the umbrella when the umbrella is in a compressed position but less than the diameter of the umbrella when the umbrella is in an uncompressed position. This leads the umbrella becoming compressed as it passes through the at least one bristle support member and plurality of bristles, resulting in the removal of water from the umbrella.

The apparatus may be fixed to a building, may be a hand-held device having a handle, or may be a device able to stand freely on its own. The apparatus may be made of lightweight materials if the apparatus needs to be lifted. If the apparatus is fixed to a building or stands on its own, heavy materials such as metal and steel may be used for the device, to keep the body of the device from moving.

The apparatus may further comprise a shell that houses the at least one bristle support member and plurality of bristles, the shell comprising a first opening allowing for the umbrella to enter the at least one bristle support member.

The apparatus may further comprise a water basin attached to the shell at below the at least one bristle support member, the water basin being removable from the shell. The shell may further comprise an umbrella stop, the umbrella stop located above the water basin. The umbrella stop prevents the end of the umbrella from entering into the water basin. The umbrella stop may also be perforated and/or have holes allowing for the drainage of water into the water basin.

The apparatus may further comprise a second opening, the second opening allowing for the passage of the umbrella, and allowing the umbrella to exit the apparatus. This may allow for an umbrella of excess length to pass through the apparatus, allowing for the entire axial length of the umbrella to pass through the apparatus, so that the majority of water is removed from the umbrella. This may also allow for additional drainage and ventilation of the apparatus.

The apparatus may further comprise a first wiping member located in the first opening in the shell and/or body of the apparatus. The apparatus may further comprise a second wiping member located in the second opening in the shell and/or body of the apparatus. The first and second wiping members may be able to shift from a compressed to open position as an umbrella passes through these members, which results in water being removed from an umbrella.

The plurality of bristles may bend as the umbrella passes through the at least one bristle support member. The plurality of bristles may also be displaced as the umbrella enters the apparatus, allowing for removal of water from the umbrella.

Another embodiment of the invention provides for an apparatus for removing water from an unfurled umbrella comprising: a shell, the shell having a top, a body, and a base, the top attached to the base via the body, and a plurality of bristles located within said body of the shell, said plurality of bristles being sized and spaced apart to receive the umbrella and to compress the umbrella and brush against the fabric of the umbrella to remove water from the umbrella as the umbrella passes through said plurality of bristles.

The proximal end of the plurality of bristles may be attached to the base of the shell and the plurality of bristles may be oriented such that the distal end of the plurality of bristles may point towards the opening in the top section of the shell.

The plurality of bristles may point in a direction angled from the opening in the top section of the shell. The plurality of bristles may also point towards the radial center of the apparatus.

The plurality of bristles may be also be located within the body of the shell and may be attached to the walls of the shell. In certain arrangements, the plurality of bristles may be held by a U-shaped hook, such that the ends of the U-shaped hook attach to the shell, and the bristle is located between the ends of the U-shaped hook.

The apparatus may further comprise a water basin located within the body of the shell. The water basin is located below the plurality of bristles such that the water removed from an umbrella is able to collect in the water basin after having been removed from an umbrella.

The top of the shell may have a lid with a reservoir, the lid able to catch excess water upon entry of the umbrella. The lid may also have a wiping member allowing for water to be removed from an umbrella. The lid at the top of the shell may also be smooth, allowing for an umbrella to enter the device without being caught.

The apparatus may also have the plurality of bristles function to spread the flap of the unfurled umbrella allowing for the removal of water. The plurality of bristles may compress the umbrella such that water is removed from the umbrella as the umbrella passes through the body of the apparatus.

The apparatus may also further comprise an inner body, the inner body located within the body of the shell, the inner body supporting the water basin and the plurality of bristles.

In various embodiments of the apparatus, the bristles may be twisted wire brushes, plastic brushes, or any other such wires, brushes or bristles than may remove water from an umbrella. The bristles may be fastened around a circular pattern on the inside of the bristle support member, or may be attached to a U-shaped hook or attachment mechanism that attaches the bristle to the body of the shell. The bristles may be arranged in an equidistant manner around the bristle support member. The bristles may be arranged and positioned to point towards the radial center of the bristle support member or may be arranged to point in an angled direction in various alternative planes to the plane formed by the bristle support member. The bristles function to spread umbrella fabric apart and wipe away moisture.

The shell disclosed by the above embodiments may be made of sheet metal, plastic, or other such materials or a combination of such materials. The shell may have a weighted base to prevent tipping of the apparatus.

The first opening in the shell is the umbrella entry point. This point may have a cap with smooth lip that keeps the umbrella spines from catching.

The water basin disclosed above may be removable from the shell. The water basin also may be weighted to prevent tipping of the apparatus. The water basin may additionally have a removable drainage container for emptying out the contents of the water basin.

The shell described above may further have a lid. The shell may further be angled downward to allow for easy insertion of umbrellas. In other embodiments, the shell may be angled horizontally or may be curved to allow for easy insertion of umbrellas.

The apparatus may have a ringed, rectangular or loop shape. The top of the apparatus or entry point may such various shapes allowing for umbrellas of various sizes and shapes to enter the apparatus.

The apparatus may be a hand-held device such that the at least one bristle support member surrounds the umbrella by at least 180 degrees and there may be a plurality of bristles located within the at least one bristle support member.

The invention further comprises a system for removing water from an umbrella comprising: an umbrella and the various embodiments of the apparatus described above, wherein said umbrella is displaced into said apparatus to remove water from said umbrella.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is an exploded perspective view of an embodiment of the present invention;

FIG. 1a is closed perspective view of the embodiment shown in FIG. 1;

FIG. 1b is a top view of the embodiment shown in FIG. 1;

FIG. 1c is a top view of the embodiment shown in FIG. 1 having the at least one bristle support member support bristles around about 180 degrees of the at least one bristle support member;

FIG. 2 is perspective view an embodiment showing an apparatus of the present invention having a curved orientation;

FIG. 2a is back view of the apparatus shown in FIG. 2 showing an umbrella pass through the apparatus of FIG. 2;

FIG. 3 is a perspective view of an embodiment of the present invention showing an apparatus having an angled orientation;

FIG. 3a is a perspective view from the back of the embodiment show in FIG. 3;

FIG. 4 is a perspective view of an embodiment of the present invention showing an apparatus having an open body that may be fixed to a wall;

FIG. 4a is an exploded view of the apparatus shown in FIG. 4;

FIG. 5 is a perspective view of an embodiment of the present invention showing an apparatus having an open body that may stand on its own;

FIG. 5a is an exploded view of the apparatus shown in FIG. 5 but may be fixed to a wall and has a water basin which is unattached to the apparatus;

FIG. 6 is a perspective view of an embodiment of the present invention showing an apparatus having a closed shell and internal shell body;

FIG. 6a is a closed view of the apparatus shown in FIG. 6;

FIG. 7 is a perspective view of an embodiment of the present invention showing an apparatus having a closed shell where the bristles are connected to the base of the shell body;

FIG. 8 is a perspective view of an embodiment of the present invention showing an apparatus having a closed shell where the bristles are connected to the umbrella stop located above the base of the shell and where the water basin is removable from the shell body;

FIG. 9 is a top view of an embodiment of the present invention showing a hand-held apparatus;

FIG. 9a is a side view of an embodiment of the present invention shown in FIG. 9;

FIG. 10 a top view of an embodiment of the present invention showing a hand-held apparatus where the bristle support member surrounds the umbrella entry by about 180 degrees.

FIG. 11 is a perspective view of an embodiment of the present invention showing a hand-held apparatus having more than one plurality of bristles and more than one bristle support member;

FIG. 11A is an exploded view of the embodiment of the present invention shown in FIG. 11;

FIG. 12 is a perspective view of an embodiment of the present invention having both bristles enclosed by a bristle support member and bristles connected directly to the body of the apparatus;

FIG. 12A is an exploded view of the embodiment of the present invention shown in FIG. 12.

### DETAILED DESCRIPTION OF THE INVENTION

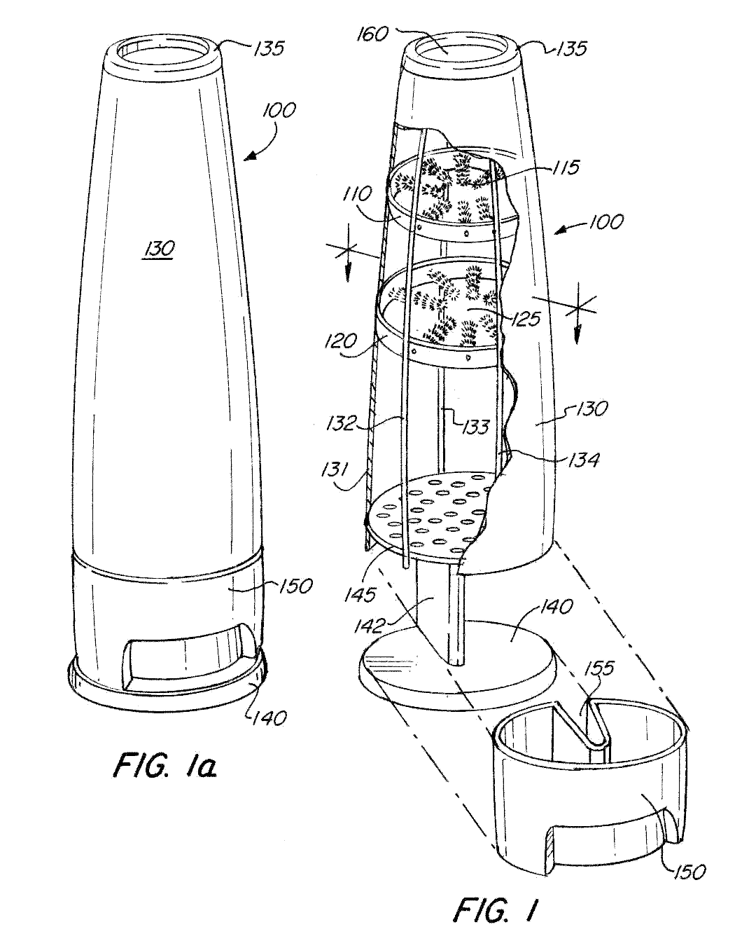

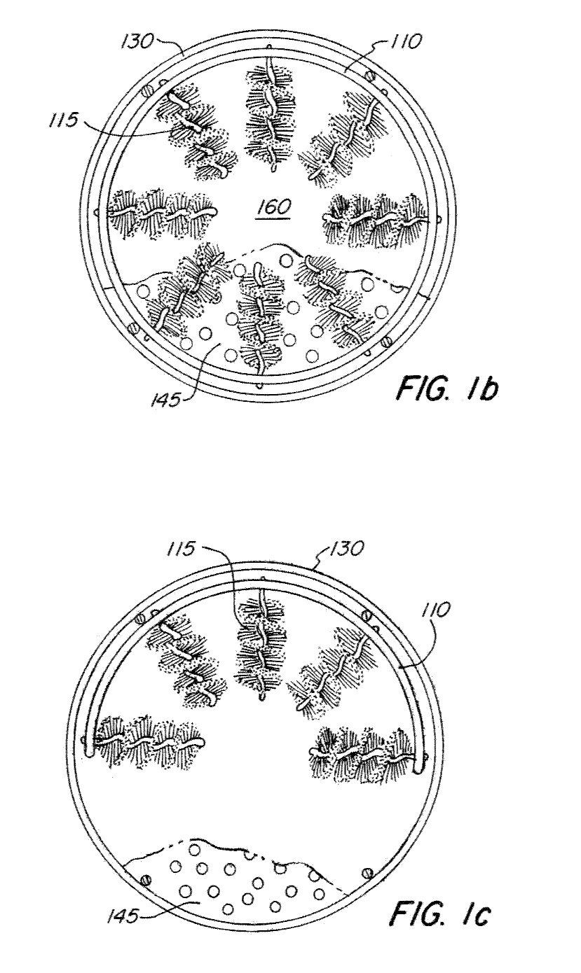

FIG. 1 illustrates a perspective view of apparatus 100 as shown by the present invention. Apparatus 100 is shown having bristle support members 110 and 120. Bristle support members 110 and 120 have plurality of bristles 115 and 125 as shown in FIG. 1. Additional bristle support member(s) may be part of apparatus 100 but only two bristle support members are shown in FIG. 1. Shell 130 is also shown having a lip 135 and base 140. Shell 130 also may have vertical supports 131, 132, 133 and 134, although the exact number of supports may vary depending upon the shape of shell 130. The vertical supports may be used to hold the bristle support members 110 and 120 in place.

In other embodiments, bristle support members 110 and 120 may be directly connected to shell 130 via welding, glue, or other such attachment technique.

FIG. 1 also shows water basin 150 in its removable state, whereby water basin 150 is removable from shell 130. Water basin 150 is used to collect the water which falls from an umbrella (not shown), as the umbrella passes through bristle support members 110 and 120 in apparatus 110. An umbrella (not shown) may enter apparatus 100 through opening 160 shown at the top of apparatus 100, allowing the umbrella to pass through apparatus 100.

Additionally, umbrella stop 145 is shown separating the internal region 190 (not shown) of shell 130 from water basin 150. Umbrella stop 145 may be perforated or have holes as shown, such that water may fall and collect in water basin 150. The shape and number of perforations of umbrella stop 145 may vary.

Base 140 is also shown having vertical support member 142. Vertical support member 142 is designed to adapt to water basin 150, allowing for water basin 150 to slide into vertical support member 142. There may be one or more vertical support member(s) 142 depending upon the design of the base unit.

Apparatus 100 functions to remove water from an umbrella (not shown) as the umbrella passes through bristle support members 110 and 120 having plurality of bristles 115 and 125, respectively. Water is removed as the umbrella fabric passes through the region of the plurality of bristles 115 and 125 and the bristles 115, 125 brush water off the umbrella fabric.

The bristle support members 110 and 120 and bristles 115 and 125 are sized and spaced apart to receive an umbrella and to simultaneously compress the umbrella and to brush liquid from the umbrella.

FIG. 1a shows apparatus 100 of FIG. 1 shown in a closed form. Here, apparatus 100 is shown having shell 130 and water basin 150 in the same vertical plane. Base 140 is also shown, base 140 preferably being weighted to support apparatus 100 and preventing it from tipping or being knocked over. The base may be made of heavy materials such as various metals, tin, aluminum, or lead to prevent the device from being moved or tipped over. Additionally, wheels (not shown) may be present at the bottom of the device allowing for easy transport of the device if a person chooses to do transport the device.

FIG. 1b is a top view of apparatus shown in FIG. 1. Here, the umbrella is shown as it enters through opening 160 into apparatus 100. Shell 130 is shown as well as bristle support member 110, bristle support member 110 being shown completely surrounding (360 degrees) plurality of bristles 115. Bristle support member 120 is not shown in this figure as it is located below bristle support member 110. Additionally, plurality of bristles 115 is shown projecting towards the radial center of bristle support member 110. Umbrella stop 145 having perforations is also shown.

FIG. 1c shows an alternate construction where bristle support member 110 is shown surrounding plurality of bristles 115, but only surrounding plurality of bristles 115 by approximately 180 degrees.

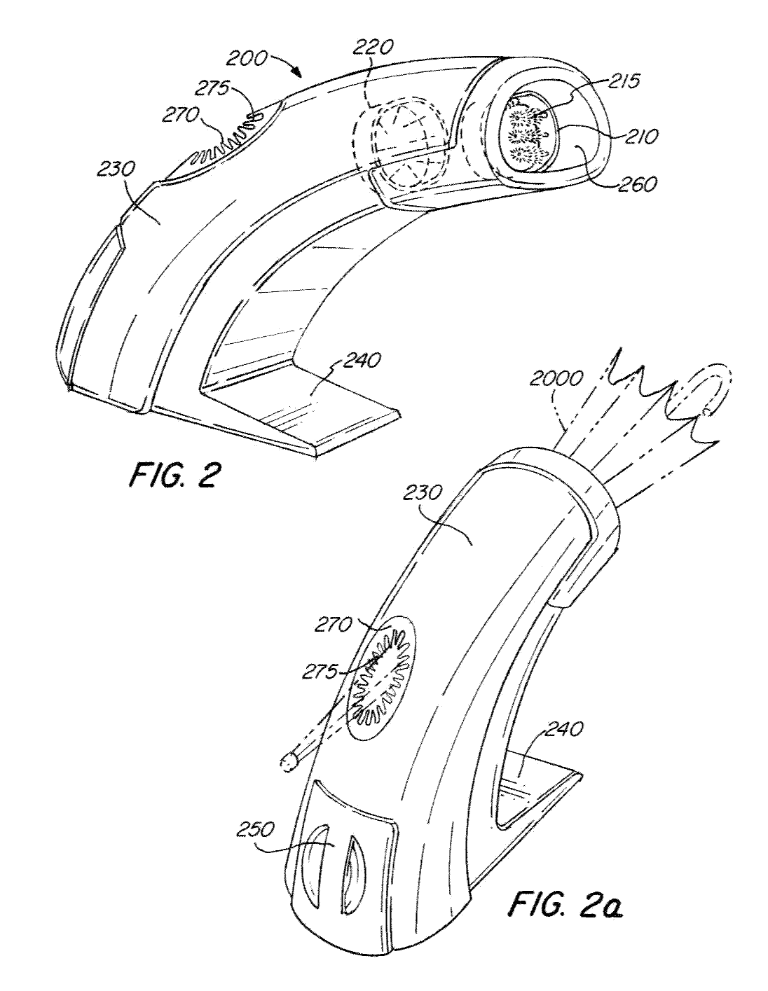

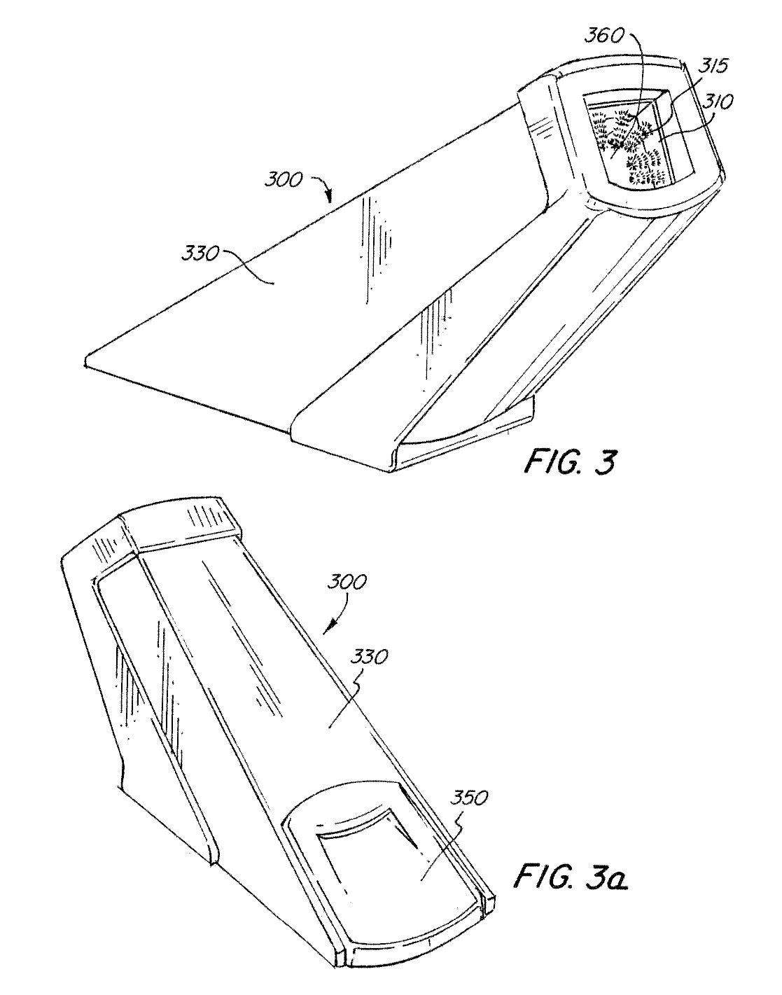

FIG. 2 shows another embodiment of the invention. Here, apparatus 200 is shown having shell 230 and bristle support members 210 and 220. Bristle support member 220 is shown in phantom. Shell 230 is shown having a curved orientation, allowing for additional ease of entry for an umbrella into apparatus 200. Plurality of bristles 215 are shown connected to bristle support member 210 and are located in opening 260 of apparatus 200. Furthermore, second opening 270 is shown in shell 230. Second opening 270 may have wiping member(s) 275. Wiping member(s) 275 are used to additionally remove water from an umbrella as it passes though apparatus 200.

FIG. 2a is a back view of apparatus 200 shown in FIG. 2 with umbrella 2000 sticking through apparatus 200. Apparatus 200 is shown having water basin 250 in this embodiment. Water basin 250 may be removed by pulling it out and separating it from apparatus 200, allowing for water from the umbrella to be drained and removed from apparatus 200.

Furthermore, a more detailed view of second opening 270 having have wiping member(s) 275 is shown in FIG. 2a, such that umbrella 2000 will have additional water removed by wiping member(s) 275. Base 240 is also shown, such base preferably being weighted to prevent apparatus 200 from moving.

FIGS. 3 and 3a shows another embodiment of the present invention showing apparatus 300 having an angled orientation allowing for additional ease of entry of an umbrella into apparatus 300. Here, plurality of bristles 315 are connected to bristle support member 310 and are located in opening 360 of apparatus 300. Water basin 350 is shown being removable from apparatus 300, allowing for water from the umbrella to be removed and/or drained from apparatus 300.

FIG. 3 also shows an umbrella entry point being substantially rectangular. The umbrella entry point may be of various shapes and the plurality of bristles may be arranged in an equidistant manner around the bristle support member or entry point of the apparatus.

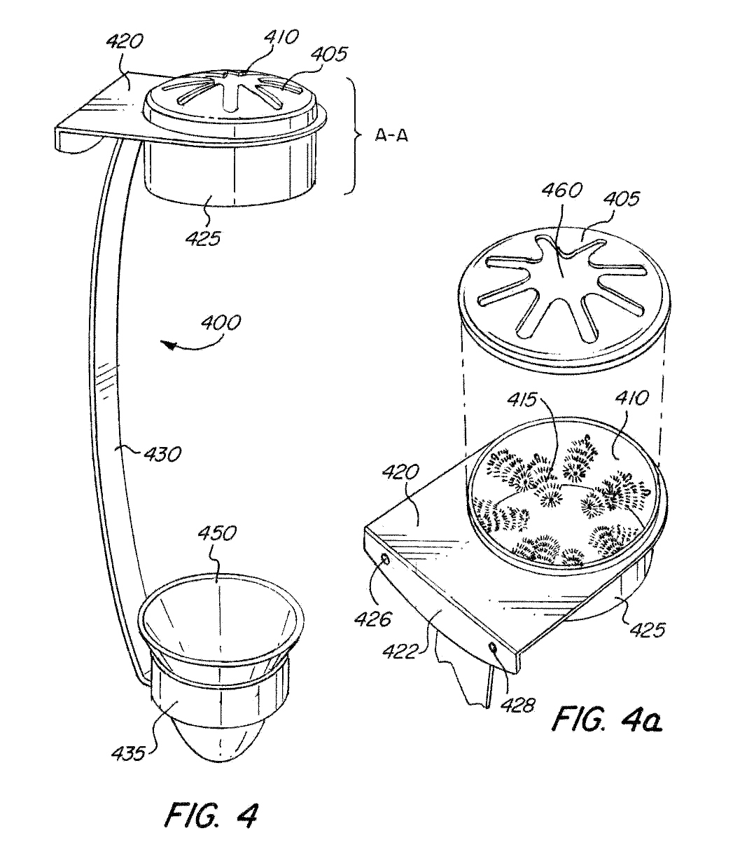

FIG. 4 shows an embodiment of the invention having apparatus 400 shown with an open body. Apparatus 400 may be attached or screwed into a wall. FIG. 4 shows body 430 which has a lower region 435 that supports water basin 450. Body 430 is also connected to top 420 which supports bristle support member 410. On top of bristle support member 410 is wiping member(s) 405. Bristle support member 410 holds plurality of bristles 415. These bristles may project radially towards the center of bristle support member 410.

As shown in FIG. 4a, top section 420 also supports bristle support member 410. Top section 420 has side section 422 with holes 426 and 428. Holes 426 and 428 may be attached to or screwed into the wall of a building (not shown).

Additionally, top section 420 has a body section 425 that allows for ease of insertion for an umbrella (not shown). FIG. 4a also shows opening 460 in bristle support member 410 allowing for an umbrella to pass through bristle support member 410 and plurality of bristles 415, and thus allowing for water to be removed from an umbrella. Wiping member(s) 405 are secured to body section 425 and may fasten apparatus 400 together.

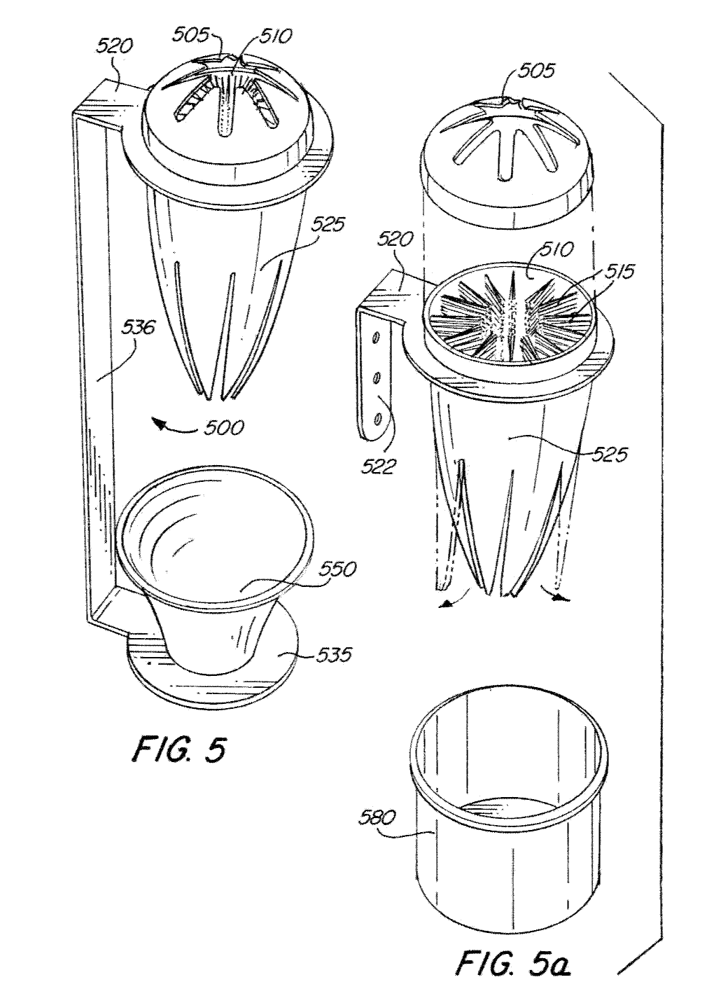

FIG. 5 shows a similar embodiment to FIG. 4, except FIG. 5 provides base 535 for apparatus 500. FIG. 5 shows body 530 connecting top section 520 with base 535. Base 535 supports removable water basin 550. Also, top section 520 supports bristle support member 510 which houses plurality of bristles 515. First wiping member 505 is shown attached to bristle support member 510. Additionally, second wiping member 525 is shown below bristle support member 510. Second wiping member 525 may flex as an umbrella passes through it.

FIG. 5a shows top section 520 of apparatus 500, except rather than having body 530, FIG. 5a shows body 522. Body 522 may be attached to a wall or building. Additionally, wiping member 525 is shown below bristle support member 510, wiping member 525 being able to be spread apart and flex due to the insertion of an umbrella (not shown). Plurality of bristles 515 are shown in this embodiment in layers and rows.

Removable water basin 580 is also shown in FIG. 5a, where removable water basin 580 is not attached at all to apparatus 500.

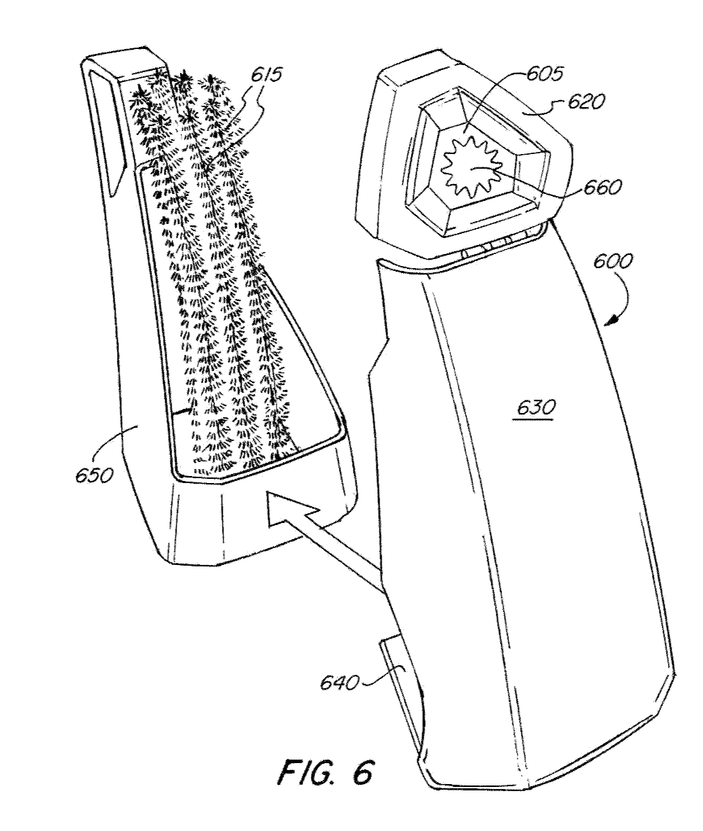

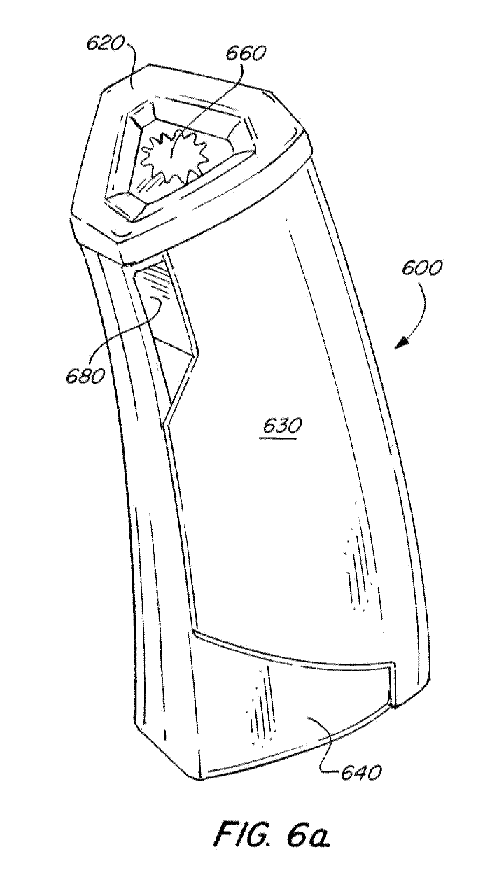

FIG. 6 shows another embodiment of the present invention. Here, apparatus 600 is shown having shell 630 with top section 620. Top section 620 is shown as a lid which may swing open. Additionally, top section 620 has opening 660 with wiping member(s) 605 set in top section 620.

Water basin 650 is also shown; however in this embodiment water basin 650 houses plurality of bristles 615. Here, plurality of bristles 615 are shown oriented vertically and point towards the direction of top section 620. The bristles are shown oriented in the direction the umbrella enters apparatus 600. Also, shell 630 contains base 640 which has a door that may swing open to allow water basin 650 to be removable from apparatus 600. This allows for water to be removed and/or drained from apparatus 600.

FIG. 6a shows the closed position of the apparatus shown in FIG. 6 having shell 630 with closed top 620 and base 640. Handle 680 is also shown attached to apparatus 600, allowing apparatus 600 to be more easily transported. Additionally wheels (not shown) may be attached to the bottom of base 640 allowing for apparatus 600 to be easily transported.

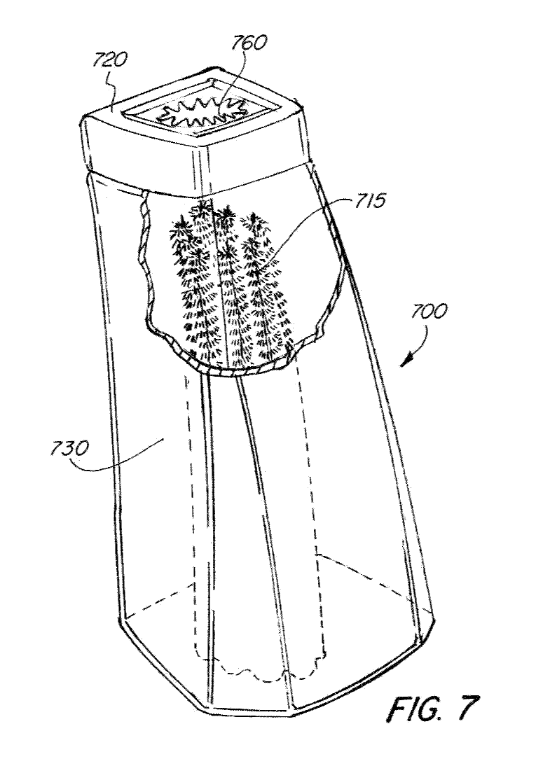

FIG. 7 is another embodiment of the invention having apparatus 700 shown. Here, plurality of bristles 715 are shown attached to base of shell 730. Apparatus 700 also has top 720, which may be a lid and may swing open. Also, opening 760 is shown allowing an umbrella to enter apparatus 700.

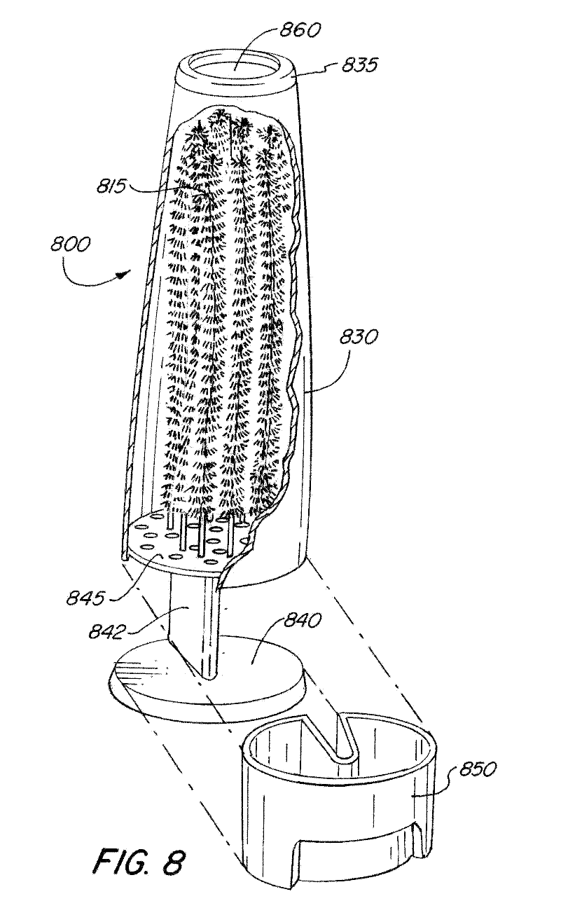

FIG. 8 is another embodiment of the invention having apparatus 800 shown. Here, plurality of bristles 815 are shown attached to umbrella stop 845. Plurality of bristles 815 are oriented vertically and in the direction that an umbrella enters apparatus 800. An umbrella enters apparatus 800 through opening 860. Apparatus 800 may have a lip 835 allowing for smooth entry of an umbrella. Additionally, base 840 is shown having vertical support member 842 as well as water basin 850 which fits into the slot between base 840 and umbrella stop 845.

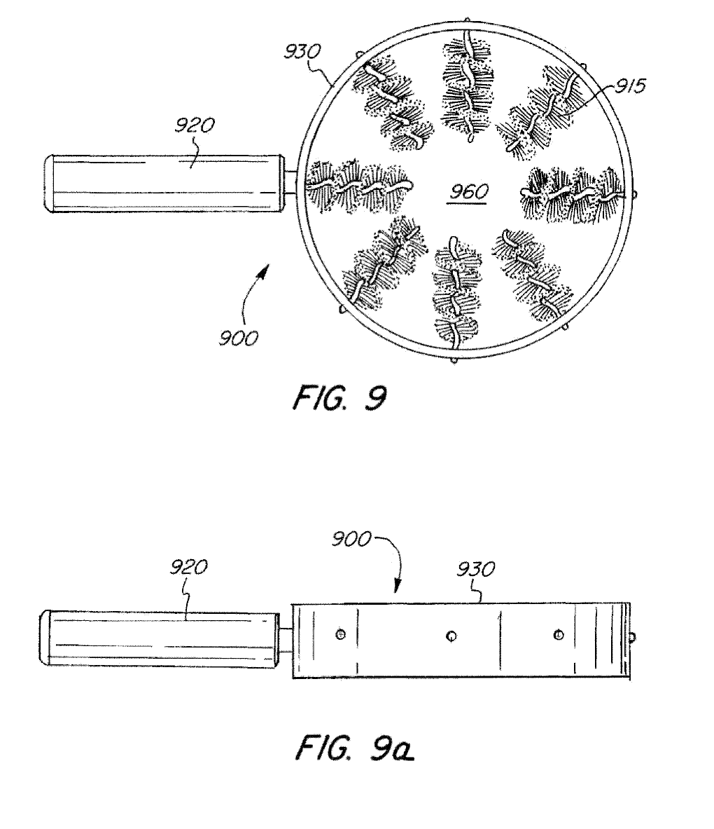

FIG. 9 shows an embodiment where hand-held apparatus 900 is shown. Here, an umbrella may enter apparatus 900 through opening 960. Bristle support member 930 is shown attached to handle 920, the bristle support member 930 supporting plurality of bristles 915. Plurality of bristles 915 are shown in an orientation directed towards the radial center of bristle support member 930, although plurality of bristles 915 may be oriented in an alternate manner.

FIG. 9a shows a side view of the embodiment shown in FIG. 9 having handle 920 and bristle support member 930.

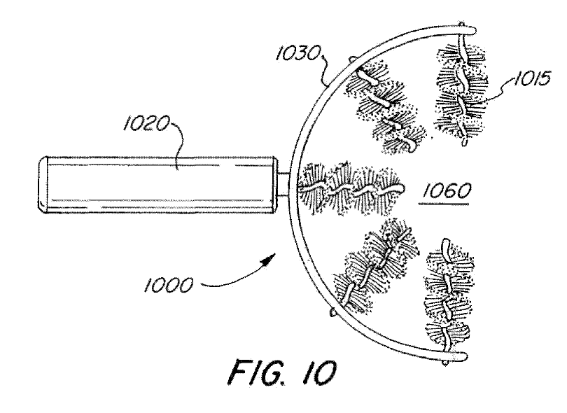

FIG. 10 shows an embodiment where hand-held apparatus 1000 is shown. Handle 1020 is connected to bristle support member 130, shown surrounding umbrella entry point 1060 by 180 degrees. As shown, bristle support member 130 is attached to plurality of bristles 1015.

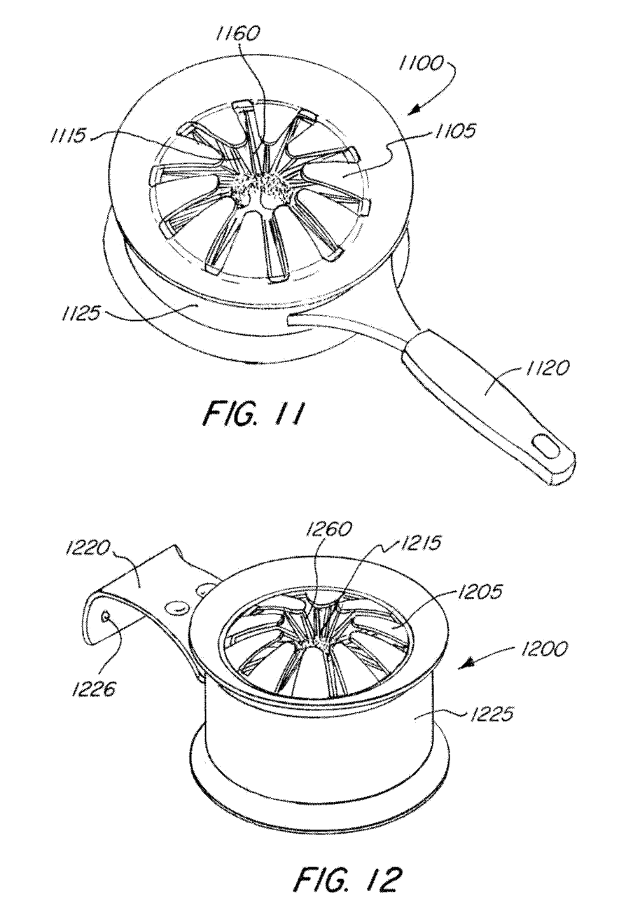

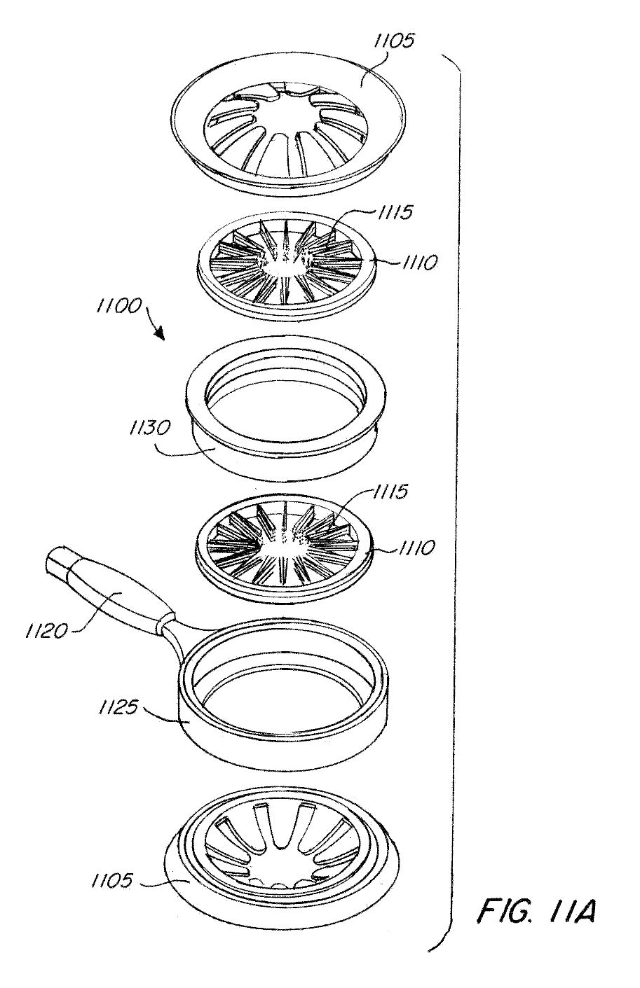

FIG. 11 shows an embodiment where hand-held apparatus 1100 is shown. Handheld apparatus 1100 has wiping member(s) 1105 attached to body section 1125. Body section 1125 is attached to handle 1120. The embodiment shows umbrella entry point 1160. Also shown is plurality of bristles 1115 inside body section 1125.

FIG. 11A shows an exploded view of the embodiment shown in FIG. 11. Here, wiping member(s) 1105 are shown above and below the body 1125. The embodiment shows two sets of plurality of bristles 1115 enclosed by bristle support member(s) 1110. Also shown in inner body 1130 which supports both bristle support member(s) 1110 and may be placed within body 1125. The device 1110 also has a handle 1120.

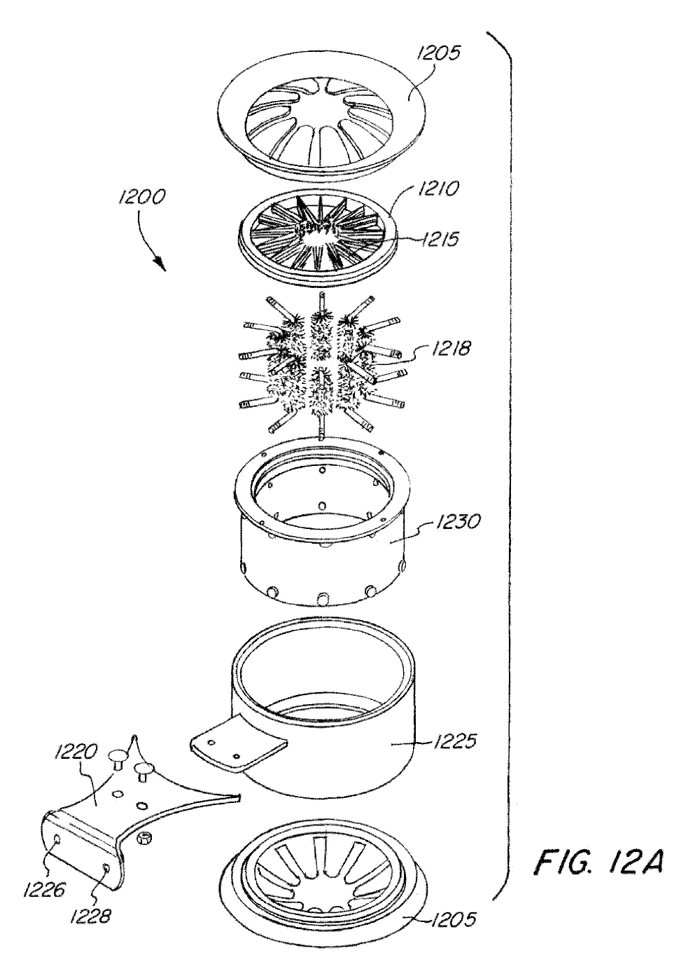

FIG. 12 shows another embodiment of the present invention. Apparatus 1200 is shown having body 1225 and wiping member(s) 1205. Handle section 1220 is also shown having holes 1226 and 1228, which allow apparatus 1200 to attach to a wall or vertical beam. Also shown are plurality of bristles 1215 and umbrella entry point 1260.

FIG. 12A shows an exploded view of the embodiment shown in FIG. 12. Here, wiping member(s) 1205 are shown above and below body 1225. Body 1225 is shown able to be connected to handle section 1220 via screws. This embodiment also has plurality of bristles 1215 shown enclosed by bristle support member 1210.

Also shown are plurality of bristles 1218, which are shown directly attached to inner body 1230. Inner body 1230 houses plurality of bristles 1218 and bristle support member 1210, which encloses plurality of bristles 1215. Thus, this embodiment shows both horizontal and vertical bristles. Plurality of bristles 1218 are shown attached to a U-shaped hook. These plurality of bristles 1218 cause an umbrella to compress as it passes through the plurality of bristles.

The embodiment also involves inner body 1230, which is enclosed within body 1225. Wiping member(s) 1105 are shown acting as both top and bottom caps and may hold apparatus 1200 together.

While the invention has been specifically described in connection with certain specific embodiments thereof, it is to be understood that this is by way of illustration and not of limitation and that various changes and modifications in form and details may be made thereto, and the scope of the appended claims should be construed as broadly as the prior art will permit.

The description of the invention is merely exemplary in nature, and thus, variations that do not depart from the gist of the invention are intended to be within the scope of the invention. Such variations are not to be regarded as a departure from the spirit and scope of the invention.

What is claimed is:

1. An apparatus for removing water from an unfurled umbrella comprising:
at least one bristle support member having an opening adapted to receive the axial length of the unfurled umbrella such that the at least one bristle support member surrounds the umbrella by at least 180 degrees,
a plurality of bristles located within said at least one bristle support member, said plurality of bristles having the proximal end of each bristle attached to said at least one bristle support member,
said at least one bristle support member and said plurality of bristles being sized and spaced apart to receive the umbrella and to compress the umbrella and brush against the fabric of the umbrella to remove water from the umbrella as the umbrella passes through said at least one bristle support member.

2. The apparatus of claim 1, wherein the diameter of the at least one bristle support member is greater than the diameter of the unfurled umbrella when the umbrella is compressed by the plurality of bristles.

3. The apparatus of claim 1, wherein the at least one bristle support member surrounds the umbrella by 360 degrees.

4. The apparatus of claim 1, wherein said plurality of bristles project radially towards the center of the at least one bristle support member.

5. The apparatus of claim 4, wherein the distance between the distal end of a first bristle and the distal end of a corresponding second bristle located across the at least one bristle support member is greater than the diameter of the umbrella when the umbrella is in a compressed position but less than the diameter of the umbrella when the umbrella is in an uncompressed position.

6. The apparatus of claim 1, wherein said apparatus is fixed to a building.

7. The apparatus of claim 1, further comprising a handle.

8. The apparatus of claim 1, further comprising a shell that houses the at least one bristle support member, said shell comprising a first opening allowing for the umbrella to enter said at least one bristle support member.

9. The apparatus of claim 8, further comprising a water basin attached to said shell below said at least one bristle support member, said water basin being removable from said shell.

10. The apparatus of claim 8, wherein said shell further comprises an umbrella stop, said umbrella stop located above said water basin.

11. The apparatus of claim 10, wherein said umbrella stop is perforated allowing for the drainage of water into said water basin.

12. The apparatus of claim 8, wherein said shell has a second opening, said second opening allowing for the passage of the umbrella.

13. The apparatus of claim 8, wherein said first opening in the shell further comprises a first wiping member.

14. The apparatus of claim 12, wherein said second opening in the shell further comprises a second wiping member.

15. The apparatus of claim 1, wherein the plurality of bristles bend as the umbrella passes through said at least one bristle support member.

16. An apparatus for removing water from an unfurled umbrella comprising:
a shell, said shell having a top, a body, and a base, said top attached to said base via said body, and
a plurality of bristles located within said body of said shell, said plurality of bristles being sized and spaced apart to receive the umbrella and to compress the umbrella and brush against the fabric of the umbrella to remove water from the umbrella as the umbrella passes through said plurality of bristles.

17. The apparatus of claim 16, wherein said proximal end of said plurality of bristles is attached to the base of said shell and said plurality of bristles are oriented such that the distal end of said plurality of bristles point towards the opening in said top section of said shell.

18. The apparatus of claim 16, further comprising a water basin located within said body of said shell.

19. The apparatus of claim 16, wherein said top of said shell has a lid with a reservoir, said lid able to catch excess water upon entry of the umbrella.

20. The apparatus of claim 16, wherein said plurality of bristles function to spread the flap of the unfurled umbrella allowing for the removal of water.

21. The apparatus of claim 18, further comprising an inner body, said inner body located within the body of said shell, said inner body supporting said water basin and said plurality of bristles.

22. A system for removing water from an umbrella comprising:
an umbrella; and
an apparatus for removing water from the umbrella when the umbrella is displaced into the apparatus, the apparatus comprising:
at least one bristle support member having an opening adapted to receive the axial length of the umbrella such that the at least one bristle support member surrounds the umbrella by at least 180 degrees,
a plurality of bristles located within said at least one bristle support member, said plurality of bristles having the proximal end of each bristle attached to said at least one bristle support member,
said at least one bristle support member and said plurality of bristles being sized and spaced apart to receive the umbrella and to compress the umbrella and brush against the fabric of the umbrella to remove water from the umbrella as the umbrella passes through said at least one bristle support member.

23. A system for removing water from an umbrella comprising:
an umbrella; and
an apparatus for removing water from the umbrella when the umbrella is displaced into the apparatus, the apparatus comprising:
a shell, said shell having a top, a body, and a base, said top attached to said base via said body, and
a plurality of bristles located within said body of said shell, said plurality of bristles being sized and spaced apart to receive the umbrella and to compress the umbrella and brush against the fabric of the umbrella to remove water from the umbrella as the umbrella passes through said plurality of bristles.
